(19) United States
(12) Patent Application Publication
(10) Pub. No.: US 2009/0019216 A1
(43) Pub. Date: Jan. 15, 2009

(54) Disk drive device and method for saving a table for managing data in non-volatile semiconductor memory in disk drive device

(76) Inventors: Shuhji Yamada, Kanagawa (JP); Toshio Kakihara, Kanagawa (JP); Tsuyoshi Satoh, Kanagawa (JP); Tsuneo Hirose, Kanagawa (JP); Kazuhiko Satake, Kanagawa (JP); Katsuhiro Imoto, Tokyo (JP); Akihiko Mouri, Tokyo (JP); Shunsuke Kagaya, Tokyo (JP); Shingo Ito, Tokyo (JP)

Correspondence Address: TOWNSEND AND TOWNSEND AND CREW LLP, TWO EMBARCADERO CENTER, 8TH FLOOR, SAN FRANCISCO, CA, 94111, US

(21) Appl. No.: 12/218,577

(22) Filed: Jul. 15, 2008

(30) Foreign Application Priority Data
Jul. 15, 2007 (JP) 2007-185112

(51) Int. Cl. G06F 12/00; G06F 12/02

(52) U.S. Cl. 711/103; 711/112; 711/E12.001; 711/E12.008

(57) ABSTRACT

Embodiments of the present invention help to suppress adverse effects on the host computer operation caused by saving a segment table. According to one embodiment, a hard disk drive (HDD) creates a segment table to associate addresses of user data in a flash memory with LBAs in a magnetic disk. The HDD updates the segment table in a DRAM and saves it to the flash memory at a specific timing. The HDD creates a journal indicating an update of the segment table and saves it to the flash memory. The segment table and the journal in the flash memory enable the latest segment table to be restored. If the HDD receives a predetermined command from a host computer, it saves the segment table in the DRAM into the flash memory.

### CROSS-REFERENCE TO RELATED APPLICATION

The instant nonprovisional patent application claims priority to Japanese Patent Application No. 2007-185112 filed Jul. 15, 2007 and which is incorporated by reference in its entirety herein for all purposes.

### BACKGROUND OF THE INVENTION

Data storage devices using various kinds of media, such as optical disks, magneto-optical disks, flexible magnetic disks, and the like have been known in the art. In particular, hard disk drives (HDDs) have been widely used as storage devices of computers and have been one of indispensable storage devices for current computer systems. Moreover, the HDDs have found widespread application to moving image recording/reproducing apparatuses, car navigation systems, cellular phones, digital cameras, and the like, in addition to use in computers, due to their outstanding characteristics.

An HDD spins a magnetic disk and moves a head slider to a target data sector to access (read or write) the magnetic disk. Therefore, the HDD consumes more electric power as compared to an access to a semiconductor memory, and has slower access speed to the magnetic disk than a semiconductor memory. Particularly, spinning a spindle motor requires more time than other operations. Accordingly, starting up the HDD and returning the HDD from a power saving mode for saving electric power requires operation time.

In order to overcome this problem, it has been proposed that a flash memory, a kind of non-volatile semiconductor memory, be implemented in a HDD (refer to Japanese Patent Publication No. 2006-114206 “Patent Document 1”, for example). Since the flash memory is a semiconductor memory, it has quicker access speed and consumes lower power than a magnetic disk. Further, since the flash memory is a non-volatile memory, it can keep data in itself even if the HDD is in a powered-off state.

The capacity of a flash memory to be implemented in an HDD is limited in view of the cost or the like. Therefore, the HDD stores specific user data in the flash memory and other user data on a magnetic disk. For example, storing data that is necessary to start up a host computer or that is frequently accessed by the host computer in the flash memory, achieves reduction in time for starting up the host computer, improvement in performance of the HDD, and reduction in power consumption during a power saving mode which reduces the rpm of the spindle motor.

The host computer instructs the HDD to write or retrieve data, specifying a logical block address (LBA), which is an address on a magnetic disk. Therefore, it is necessary that the HDD associate the LBA of user data stored in the flash memory with an address in the flash memory. Specifically, the HDD creates a table to correlate the above two kinds of addresses with each other and refers to the table to access the magnetic disk and the flash memory. Hereinafter, the table is called a segment table.

The segment table is used alter powered off and then powered on again. Therefore, the HDD stores the segment table on a magnetic disk or in a flash memory; the both of them are non-volatile memories. Typically, the segment table is stored in a flash memory. However, since the flash memory requires a delete and a write operations to rewrite data, frequent updates of the segment table cause degradation in performance.

In response, an idea has been proposed that loads the segment table in a RAM and updates the segment table in the RAM. In addition, it creates log data indicating the updated contents of the segment table and stores the log data in a flash memory. An example of the use of the log data in an HDD is disclosed in a Japanese Patent Publication No. 2005-115857 (“Patent Document 2”).

The stored log data enables the latest segment table to be restored using the segment table and the log data in a flash memory even if the latest segment table in a RAM has been deleted due to a power shutdown. Meanwhile, the contents of the segment table in the RAM must be reflected in the segment table in the flash memory at some timing. Since some operating time is necessary to update the segment table in the flash memory, it is important to suppress adverse effects on the host computer operation.

### BRIEF SUMMARY OF THE INVENTION

Embodiments of the present invention help to suppress adverse effects on the host computer operation caused by saving a segment table. According to one embodiment, a hard disk drive (HDD) creates a segment table to associate addresses of user data in a flash memory with LBAs in a magnetic disk. The HDD updates the segment table in a DRAM and saves it to the flash memory at a specific timing. The HDD creates a journal indicating an update of the segment table and saves it to the flash memory. The segment table and the journal in the flash memory enable the latest segment table to be restored. If the HDD receives a predetermined command from a host computer, it saves the segment table in the DRAM into the flash memory.

### BRIEF DESCRIPTION OF THE DRAWINGS

FIG. 1 is a block diagram schematically depicting an entire configuration of a hard disk drive according to one embodiment.

FIG. 2 is a block diagram schematically illustrating components for saving user data in one embodiment.

FIGS. 3(a) and 3(b) are diagrams schematically illustrating formats of a record in the segment table and a journal according to one embodiment.

FIGS. 4(a) and 4(b) are diagrams schematically illustrating an example of restoration of the segment table using journals according to one embodiment.

FIG. 5 is a block diagram schematically depicting processes in response to a receipt of a command to order a change to the PIN area according to one embodiment.

FIG. 6 is a flowchart illustrating a flow of the processes in response to a receipt of a command to order a change to the PIN area according to one embodiment.

FIG. 7 is a block diagram schematically depicting processes in response to a receipt of a command to order a transfer of user data in the flash memory to a magnetic disk according to one embodiment.

FIG. 8 is a flowchart illustrating a flow of the processes in response to a receipt of a command to order a transfer of user data in the flash memory to a magnetic disk according to one embodiment.

FIG. 9 is a flowchart illustrating a flow of the processes in response to a receipt of a command to order a return from the mode for stopping spin of the magnetic disk and saving user data to the flash memory according to one embodiment.

FIG. 10 is a flowchart illustrating a flow of the processes when the size of journals in the journal area in the flash memory exceeds a reference value according to one embodiment.

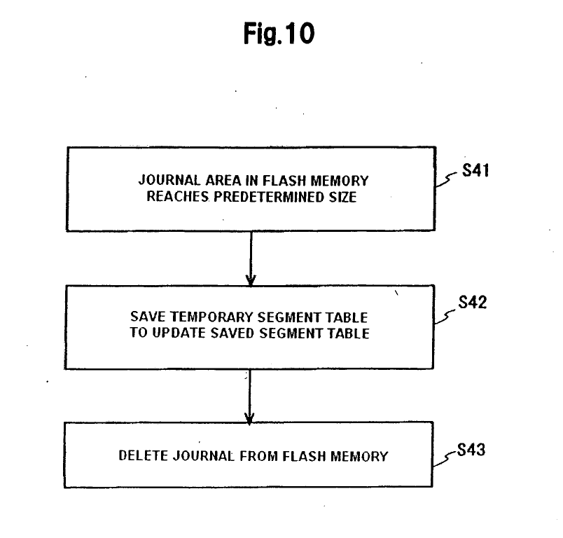

### DETAILED DESCRIPTION OF THE INVENTION

Embodiments of the present invention relate to a disk drive device equipped with a disk and a non-volatile semiconductor memory for saving user data, and a method for saving a table for managing data in a non-volatile semiconductor memory area in the disk drive device.

A disk drive device according to an aspect of embodiments of the present invention comprises a disk memory area for saving user data, a non-volatile semiconductor memory area for saving user data, a buffer memory area for storing a temporary segment table which associates addresses of user data saved in the non-volatile semiconductor memory with addresses in the disk memory area for the user data and is updated as required, a non-volatile memory area for saving journals indicating update histories of the temporary segment table, and a controller. The controller reflects contents of the temporary segment table in a saved segment table saved in a non-volatile memory area in response to a receipt of a predetermined command or one of predetermined commands from a host computer. Reflection of the contents of the temporary segment table in the saved segment table in response to a predetermined command achieves saving of a segment table, suppressing adverse effects on the host computer operation.

The predetermined command or commands may include a command accompanied by a user data transfer between the non-volatile semiconductor memory area and the disk memory area. This achieves effective saving of the segment table.

The device may further comprise a buffer SRAM for temporarily storing the journals before the journals are transferred to the non-volatile semiconductor memory area. This achieves shorter operating time.

User data corresponding to predetermined addresses in the disk memory area may be saved to the non-volatile semiconductor memory area, and the predetermined command or commands include a command to change the predetermined addresses. Or, the predetermined command or commands may include a command to transfer user data saved in the non-volatile semiconductor memory to the disk memory area, or the predetermined command or commands may include a command to order a recovery from a mode for stopping spin of the disk and saving user data to the non-volatile semiconductor memory area. These achieve effective saving of the segment table.

The controller may reflect the contents of the temporary segment table in the saved segment table saved in the non-volatile memory area if the size of the non-volatile memory area in which the journals are saved exceeds a reference value. This achieves limitation of occupied area in the non-volatile memory.

Another aspect of embodiments of the present invention is a method for saving a table for managing data in a non-volatile semiconductor memory area in a disk drive device comprising a disk memory area and the non-volatile semiconductor memory area for saving user data. This method updates as required a temporary segment table which associates addresses of user data saved in the non-volatile semiconductor memory area with addresses in the disk memory area for the user data in a buffer memory area. It saves journals indicating update histories of the temporary segment table to a non-volatile memory area. It reflects contents of the temporary segment table in a saved segment table saved in a non-volatile memory area in response to a receipt of a predetermined command or one of predetermined commands from a host computer. Reflection of the contents of the temporary segment table in the saved segment table in response to a receipt of a predetermined command achieves saving of the segment table, suppressing adverse effects on the host computer operation.

Embodiments of the present invention achieve saving of a segment table which associates disk addresses with addresses in a non-volatile semiconductor memory, suppressing adverse effects on the host computer operation.

Hereinafter, embodiments to which the present invention is applicable will be described. For clarity of explanation, the following descriptions and accompanying drawings may have omissions and simplifications as appropriate. Throughout the drawings, like components are denoted by like reference numerals and repetitive descriptions are omitted as not necessary. Hereinbelow, a hard disk drive (HDD) will be described as an example of a disk drive device.

A HDD according to one embodiment is equipped with a flash memory in addition to a magnetic disk as a non-volatile memory for saving user data. The flash memory is a non-volatile semiconductor memory. In order to manage user data saved in the flash memory, the HDD creates a table to associate addresses in the flash memory with the addresses (LBA) on the magnetic disk for the user data. The table will be referred to as a segment table hereinafter.

The HDD updates the segment table in a RAM and saves it to the flash memory at a specific timing. The HDD according to the present embodiment further creates log data indicating updates in the RAM and saves them to the flash memory. The log data will be referred to as a journal hereinafter. When an accident such as an unexpected power shutdown occurs, the HDD restores the latest segment table using the segment table and the journal in the flash memory.

When the HDD receives a given command from a host computer, it reflects updated contents of the segment table in the RAM in the segment table in the flash memory. Specifically, the HDD deletes the segment table in the flash memory and saves the segment table in the RAM to the flash memory. The above-described given command is a preset command relating to the flash memory. In particular, a command accompanied by a transfer of user data between the magnetic disk and the flash memory is selected as the above-described given command. Saving the segment table in response to the preset command relating to the flash memory suppresses adverse effects on the performance caused by saving the segment table.

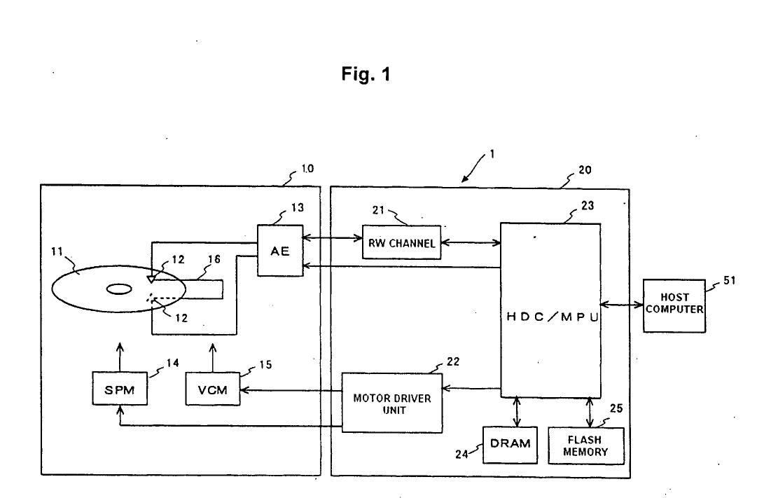

First, an entire configuration of an HDD according to the present embodiment will be outlined referring to the block diagram of FIG. 1. The HDD 1 comprises a circuit board 20 fixed outside an enclosure 10. On the circuit board 20, circuits such as a read-write channel (RW channel) 21, a motor driver unit 22, an integrated circuit (HDC/MPU) 23 of a hard disk controller (HDC) and an MPU, and a DRAM 24 of a volatile semiconductor memory, a flash memory 25 of a non-volatile semiconductor memory, and the like are mounted. In the enclosure 10, a spindle motor (SPM) 14 spins a magnetic disk 11 at a specific angular rate. The magnetic disk 11 is a disk for saving data. The motor driver unit 22 drives the SPM 14 according to control data from the HDC/MPU 23.

Head sliders 12 each comprises a slider flying over the magnetic disk and a head element portion fixed to the slider for converting magnetic signals to and from electric signals (writing and reading data). Each head slider 12 is fixed at the tip end of an actuator 16. The actuator 16, which is coupled to a voice coil motor (VCM) 15, pivots about a pivotal shaft to move the head slider 12 above the spinning magnetic disk 11 in its radial direction. The motor driver unit 22 drives the VCM 15 according to control data from the HDC/MPU 23. An arm electronics (AE) 13 selects a head slider 12 to access (read or write) the magnetic disk 11 from multiple head sliders 12 according to control data from the HDC/MPU 23 and amplifies read/write signals.

The RW channel 21, in a read operation, extracts servo data and user data from read signals obtained from the AE 13 to decode them. The decoded data are supplied to the HDC/MPU 23. In a write operation, the RW channel 21 code-modulates write data supplied from the HDC/MPU 23 and converts the code-demodulated data into write signals to supply them to the AE 13. In the HDC/MPU 23, the HDC is a logic circuit and the MPU operates according to firmware loaded in the DRAM 24. With start-up of the HDD 1, data required for control and data processing are loaded into the DRAM 24 from the magnetic disk 11 or a ROM (not shown). The HDC/MPU 23 is an example of a controller and performs entire control of the HDD 1 as well as processes necessary for data processing such as head positioning control, interface control, and defect management, and the like.

The HDC/MPU 23 saves a part of user data from a host computer 51 to a flash memory 25. Whether or not to save the user data in the flash memory 25 to the magnetic disk 11 as well can be decided depending on the design. Data to be saved to the flash memory 25 can be identified with the LBA on the magnetic disk 11. When the HDC/MPU 23 receives a write command to the predetermined LBA, it saves the user data to the flash memory 25. The HDC/MPU 23 can determine the LBA for the user data to be saved to the flash memory 25 by itself and saves the user data at the LBA specified by the host computer 51 to the flash memory 25.

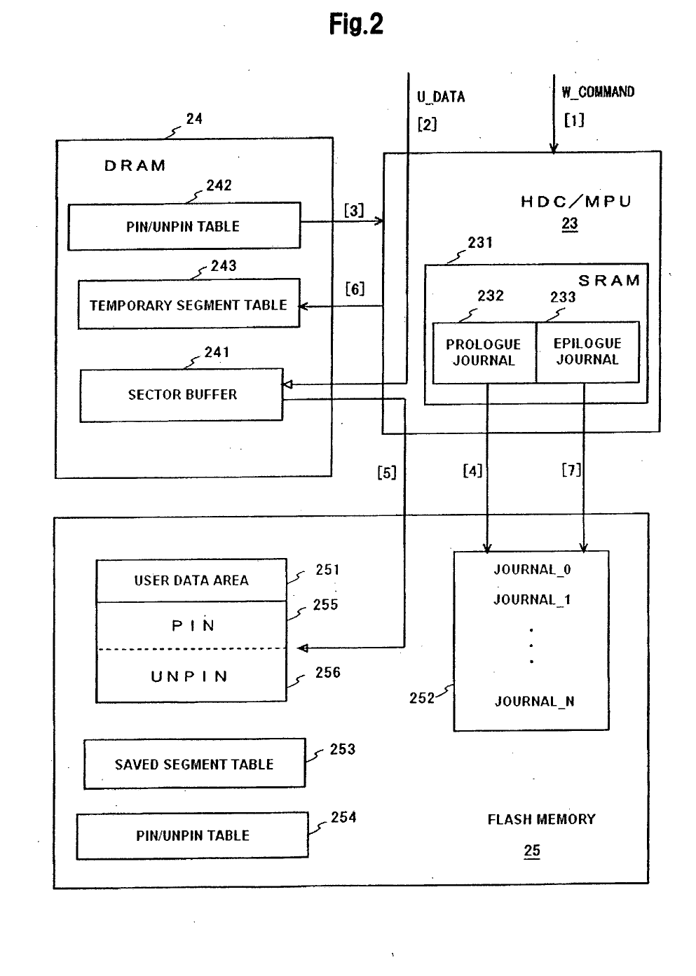

FIG. 2 is a block diagram schematically illustrating logic components relating to operation for saving user data to the flash memory 25. A PIN/UNPIN table 242 in the DRAM 24 indicates a magnetic address area for the data to be saved to the flash memory 25. The PIN area and the UNPIN area are areas for a part of magnetic disk addresses indicated by LBAs. The PIN area is the area that the host computer 51 specifies as an address area to be saved to the flash memory 25. The UNPIN area is the area that the HDC/MPU 23 itself selects as an address area to be saved to the flash memory 25.

The HDC/MPU 23 loads the PIN/UNPIN table 254 saved in the flash memory 25 into the DRAM 24. The HDC/MPU 23 performs processes referring to the PIN/UNPIN table 242 in the DRAM 24 in a write operation. If the HDC/MPU 23 changes the PIN/UNPIN table 242 in the DRAM 24, it reflects the change in the PIN/UNPIN table 254 in the flash memory 25.

Specific user data U_DATA transferred from the host computer 51 are stored into a sector buffer in the DRAM 24 and then are saved to the flash memory 25. A user data area 251 has been allocated in the flash memory 25 and user data are saved there. As described above, data to be saved to the flash memory 25 are PIN data and UNPIN data which are saved in a PIN area 255 and an UNPIN area 256 in the user data area 251, respectively.

The HDC/MPU 23 loads the saved segment table 253 in the flash memory 25 into the DRAM 24. A temporary segment table 243 which is a segment table in the DRAM 24 is referred by the HDC/MPU 23 in read and write operations of user data. The segment tables 243 and 253 locate the addresses for the user data saved in the flash memory 25. Specifically, the segment tables 243 and 253 associate flash memory addresses with magnetic disk addresses. The host computer 51 instructs a data write specifying the LBA, which is an address on the magnetic disk 11. The segment tables 243 and 253 store the LBA and the address in the flash memory 25 correlating them with each other.

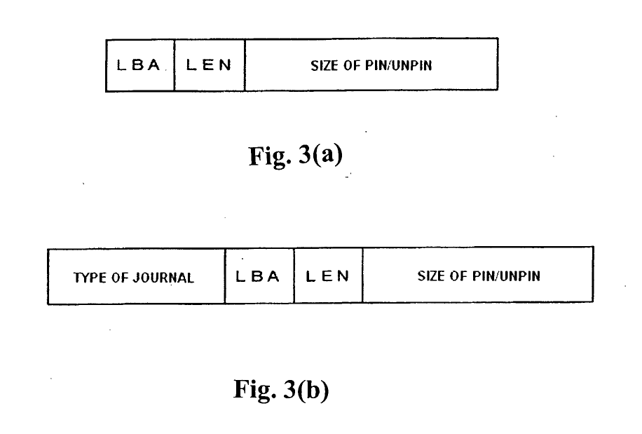

FIG. 3(a) schematically illustrates a format of a record in the segment tables 243 and 253. A record comprises a start LBA of the user data saved in the flash memory 25, a data length LEN expressed by the number of data sectors, and the size of a PIN/UNPIN. The size of the PIN/UNPIN indicates the size of the PIN area 255 or the size of the UNPIN area 256 in the user data area 251. In the PIN area 255 or the UNPIN area 256, user data are stored in order from their start addresses so that identification of the size of the PIN/UNPIN leads to identification of a data position in the PIN area 255 or the UNPIN area 256.

The HDC/MPU 23 updates the temporary segment table 243 in response to an access to (read from or write to) the flash memory 25. The HDC/MPU 23 does not reflect the updated contents of the saved segment data table 253 in the flash memory 25 immediately, but creates a journal, which is a log indicating the updated contents. The HDC/MPU 23 includes an SRAM 231 and stores the created journal in the SRAM 231. Created journals are saved as required to an area 252 in the flash memory 25. Use of the SRAM 231 for storing the journals before saving leads to a quicker process speed than use of a DRAM. Saving the journals from the SRAM 231 into the flash memory 25 can be carried out quicker than from a DRAM, too.

FIG. 3(b) schematically shows a format of a journal. A journal comprises data indicating the type of the journal, a start LBA, a data length LEN, and the size of a PIN/UNPIN. The LBA, the LEN, and the size of the PIN/UNPIN are the same as the data in a record in the segment tables 243 and 253. There are a plurality types of journals; a prologue journal and an epilogue journal will be described in the present specification. The HDC/MPU 23 updates a temporary segment table 243 after creating a prologue journal 232, and then creates an epilogue journal 233. This enables accurate restoration of the segment table even if an accident such as a power shutdown occurs during updating the temporary segment table 243.

Now referring to FIG. 2, an example of saving user data to the flash memory 25 and the accompanying update of the temporary segment table 243 and saving journals will be explained. The HDC/MPU 23 receives a write command W_COMMAND from the host computer 51 [1]. Then, the HDC/MPU 23 receives user data U_DATA and stores them in a sector buffer 241 [2]. The HDC/MPU 23 refers to the PIN/UNPIN table 242 in the DRAM 24 to determine whether or not the LBA specified by the write command W_COMMAND is present in the PIN or UNPIN area [3]. In the present example, it is assumed that the specified LBA is present in one of the areas.

The HDC/MPU 23 creates a prologue journal 232 and saves it to a journal area 252 in the flash memory 25 [4]. Next, the HDC/MPU 23 saves the user data U_DATA in the sector buffer 241 to a user data area 251 in the flash memory 25 [5]. Then, the HDC/MPU 23 updates a temporary segment table 243 [6]. Finally, the HDC/MPU 23 creates an epilogue journal 233 and saves it to the journal area 252 in the flash memory 25 [7].

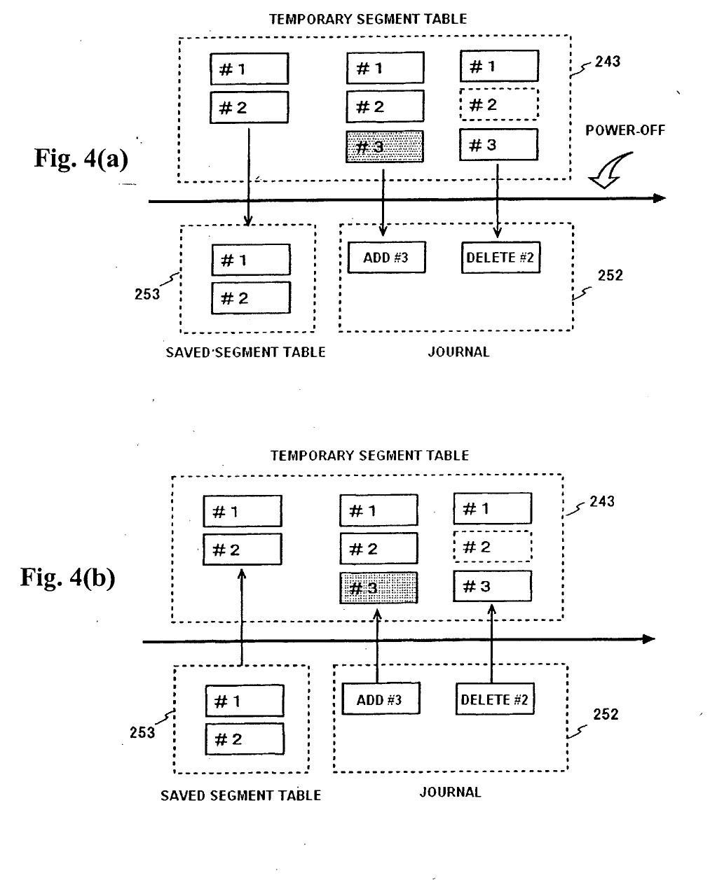

Next, an example of restoration of the segment table using journals after an accidental power shutdown will be described referring to FIGS. 4(a) and 4(b). In FIG. 4(a), the arrow directing from the left to the right represents the elapsed time. The following processes are performed by the HDC/MPU 23. The first process saves records #1 and #2 stored in the temporary segment table 243 to the saved segment table 253. The next process adds a record #3 to the temporary segment table 243 and saves a journal indicating the addition to the journal area 252. The next process deletes the record #2 from the temporary segment table 243 and saves a journal indicating the deletion to the journal area 252. After this stage, a power shutdown arises.

Upon recovery of the power, a restoration process shown in FIG. 4(b) starts. The first process in FIG. 4(b) loads records #1 and #2 in the saved segment table into the DRAM 24 to create a temporary segment table 243. The next process adds a record #3 to the temporary segment table 243 according to the journal indicating the addition of the record #3. The last process deletes the record #2 from the temporary segment table 243 according to the journal indicating the deletion of the record #2. This process completes the restoration of the temporary segment table 243. If necessary, the temporary segment table 243 may be saved at this timing.

In the above description, saving journals leads to shorter operating time than saving the segment table every time and enables the segment table to be restored even if an accident such as an unexpected power shutdown has occurred. In particular, a flash memory requires a write of new data after a deletion of data in a unit of block for rewriting data. Namely, in order to update the saved segment table 253, the flash memory 25 deletes a block including the area storing the table and then writes a new saved segment table 253 to the deleted block. Generally, the saved segment table has a binary tree data structure, a linear list, or a hash table for high-speed search; it requires an entire rewrite even in adding a part of data. On the other hand, the flash memory 25 writes new journals into its journal area 252 as needed. This write operation does not require a delete operation so that the operating time is extremely shortened.

Storing up journals without saving the updated segment table to the flash memory 25, however, leads to waste of area in the flash memory 25. Therefore, the saved segment table 253 should be updated and the journals in the flash memory 25 should be deleted at specific timings. However, since saving a segment table requires longer operating time, it is important to take performance degradation into account.

When the HDC/MPU 23 according to the present embodiment receives a predetermined command relating to the flash memory 25 from the host computer 51, it saves the temporary segment table 243 to the flash memory 25. Specifically, the command is a command to order a change to the PIN area, a command to order a transfer of the user data in the flash memory 25 to the magnetic disk 11, or a command to order a return from the mode for stopping the spin of the magnetic disk 11 and saving user data to the flash memory.

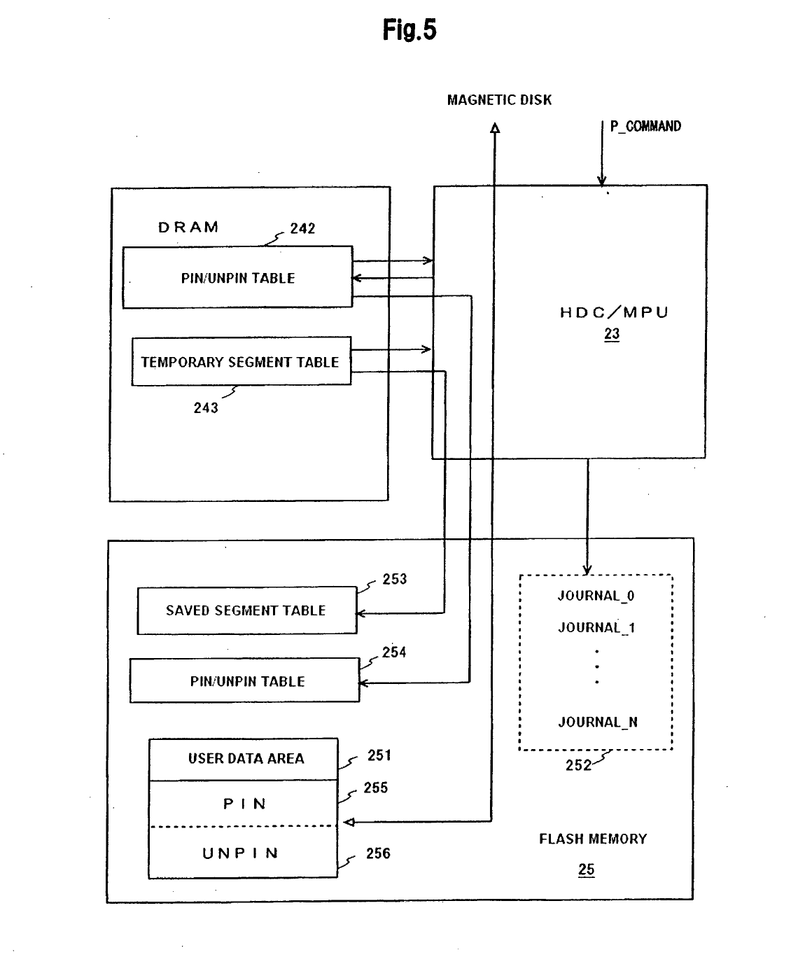

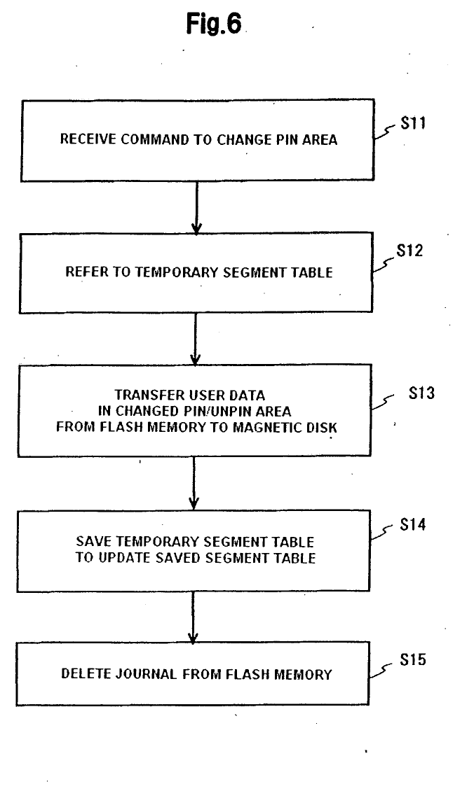

First, processes in response to a receipt of a command to order a change to the PIN area will be described referring to the block diagram of FIG. 5 and the flowchart of FIG. 6. The HDC/MPU 23 receives a command P_COMMAND to order a change to the PIN/UNPIN area from the host computer 51 (S11). The HDC/MPU 23 refers to the temporary segment table 243 to locate the addresses of the user data to be transferred between the magnetic disk 11 and the flash memory 25 due to the change of the PIN/UNPIN area (S12).

If the PIN area increases, the user data in the increased area are transferred from the magnetic disk 11 to the flash memory 25. Or, if the PIN area decreases, the user data in the deleted PIN area is transferred from the flash memory 25 to the magnetic disk 11 (S13). Upon completion of the data transfer, the HDC/MPU 23 saves the temporary segment table 243 to the flash memory 25 to update the saved segment table 253 (S14). If there is no relevant user data, the data transfer is omitted. Then, the HDC/MPU 23 deletes the data in the journal area 252 (S15).

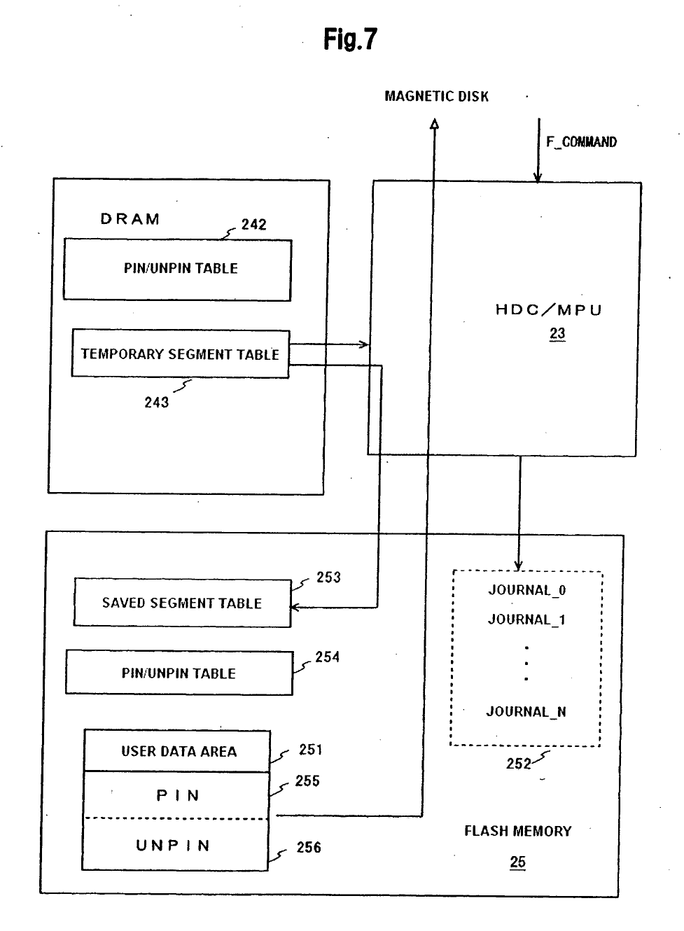

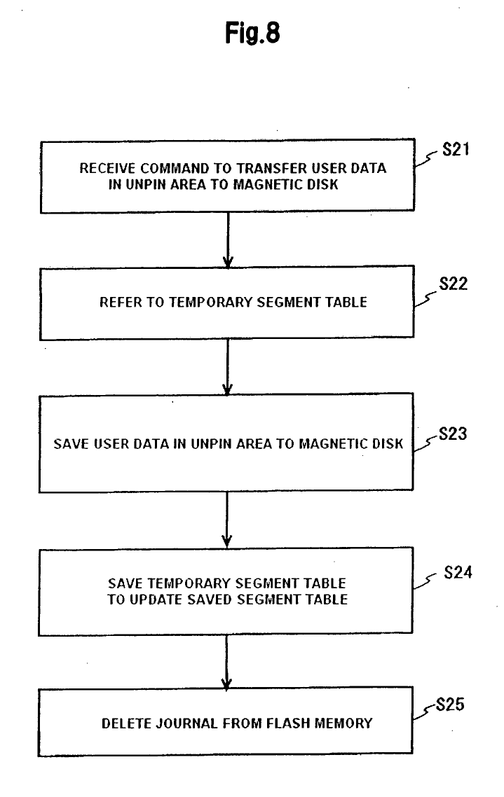

Next, processes in response to a receipt of a command to order a transfer of user data in the flash memory 25 to the magnetic disk 11 will be described referring to the block diagram of FIG. 7 and the flowchart of FIG. 8. If the HDC/MPU 23 receives such a command, it transfers the user data in the UNPIN area in the flash memory 25 to the magnetic disk 11. It releases a certain area in the flash memory 25. Specifically, the HDC/MPU 23 receives a command F_COMMAND to order a data transfer from the flash memory 25 to the magnetic disk 11 from the host computer 51 (S21). The HDC/MPU 23 refers to the temporary segment table 243 to locate the addresses of the user data to be transferred to the magnetic disk 11 (S22). The HDC/MPU 23 transfers the data in the UNPIN area 256 in the user data area 251 to the magnetic disk 11 (S23).

Upon completion of saving the data to the magnetic disk 11 the HDC/MPU 23 saves the temporary segment table 243 to the flash memory 25 to update the saved segment table 253 (S24). If there is no relevant user data, the data transfer is omitted. Then, the HDC/MPU 23 deletes the data in the journal area 252 (S25).

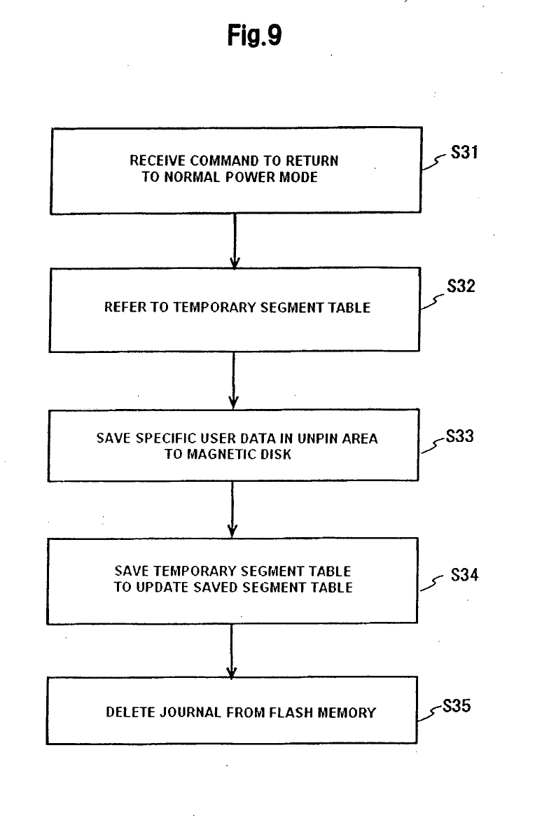

Next, processes in response to a receipt of a command to order a return from the mode for stopping spin of the magnetic disk 11 and saving user data to the flash memory will be described referring to the flowchart of FIG. 9. This mode achieves reduction in power consumption by stopping the spin of the magnetic disk 11 while maintaining an interface to the host computer 51. If the HDC/MPU 23 receives a command to order a return from such mode to a normal operation mode (S31), the HDC/MPU 23 locates the addresses of the user data to be transferred to the magnetic disk 11, referring to the temporary segment table 243 (S32). The HDC/MPU 23 transfers the data in the UNPIN area 256 in the user data area 251 to the magnetic disk 11 (S33).

Upon completion of saving the data to the magnetic disk 11 the HDC/MPU 23 saves the temporary segment table 243 to the flash memory 25 to update the saved segment table 253 (S34). If there is no relevant user data, the data transfer is omitted. Then, the HDC/MPU 23 deletes the data in the journal area 252 (S35).

The above three commands are related to the flash memory 25 and delay in the processes is more acceptable to the host computer. Further, the above three commands are common in that the processes responsive to these commands accompanied by user data transfer between the flash memory 25 and the magnetic disk 11. Although the data transfer is occasionally not necessary, there is high probability of data transfer. The contents of the temporary segment table 243 change with the data transfer. If the temporary segment table 243 significantly changes like this, it is preferable to save the temporary segment table 243 instead of saving journals.

In the above examples, the temporary segment table 243 is saved in response to a command from the host computer 51. In another example the HDC/MPU 23 according to the present embodiment saves the temporary segment table 243 if the size (number) of journals in the journal area 252 in the flash memory 25 exceeds a reference value. Specifically, if the journals in the journal area 252 in the flash memory 25 exceeds a reference size (S41), the HDC/MPU 23 saves the temporary segment table 243 to the flash memory 25 to update the saved segment table 253 (S42). Then, the HDC/MPU 23 deletes the data in the journal area 252 (S43).

Besides, the HDC/MPU 23 saves the temporary segment table 243 in an idling state in which it is not engaged in responsive processes to commands from the host computer 51. This suppresses adverse effects on the operation of the host computer 51 to the minimum. The HDC/MPU 23 saves the temporary segment table 243 to the flash memory 25 to update the store segment table 253 and clear the journal area 252 in the same way as in the above examples.

As set forth above, the present invention is described by way of particular embodiments but is not limited to the above embodiments and can of course be modified in various ways within the scope of the substance of the present invention. For example, in the above embodiments, an HDD has been described by way of example but embodiments of the present invention can be applied to a disk drive device using other types of disks such as an optical disk and a magneto-optical disk.

The segment table is preferably saved to a non-volatile semiconductor memory as described above, but may be saved to a magnetic disk of a non-volatile memory. A memory other than a flash memory may be used as the non-volatile semiconductor memory. Or, a plurality of ICs may be used to form a memory area of the non-volatile semiconductor memory. A memory area is not limited by the number of elements such as ICs or disks. The commands accompanied by saving the temporary segment table are not limited to the above examples and the data format of the segment table or the journal may be changed depending on the design. All of the above described timings for saving the segment table are not necessary to be implemented in an HDD but a part of them may be implemented.

What is claimed is:

1. A disk drive device comprising:
a disk memory area for saving user data;
a non-volatile semiconductor memory area for saving user data;
a buffer memory area for storing a temporary segment table which associates addresses of user data saved in the non-volatile semiconductor memory with addresses in the disk memory area for the user data and is updated as required;
a non-volatile memory area for saving journals indicating update histories of the temporary segment table; and
a controller for reflecting contents of the temporary segment table in a saved segment table saved in a non-volatile memory area in response to a receipt of a predetermined command or one of predetermined commands from a host computer.

2. The disk drive device according to claim 1, wherein the predetermined command or commands include a command accompanied by a user data transfer between the non-volatile semiconductor memory area and the disk memory area.

3. The disk drive device according to claim 1 further comprising:
a buffer SRAM for temporarily storing the journals before the journals are transferred to the non-volatile semiconductor memory area.

4. The disk drive device according to claim 1, wherein
user data corresponding to predetermined addresses in the disk memory area are saved to the non-volatile semiconductor memory area; and
the predetermined command or commands include a command to change the predetermined addresses.

5. The disk drive device according to claim 1, wherein the predetermined command or commands include a command to transfer user data saved in the non-volatile semiconductor memory to the disk memory area.

6. The disk drive device according to claim 1, wherein the predetermined command or commands include a command to order a recovery from a mode for stopping spin of the disk and saving user data to the non-volatile semiconductor memory area.

7. The disk drive device according to claim 1, wherein the controller reflects the contents of the temporary segment table in the saved segment table saved in the non-volatile memory area if the size of the non-volatile memory area in which the journals are saved exceeds a reference value.

8. A method for saving a table for managing data in a non-volatile semiconductor memory area in a disk drive device comprising a disk memory area and the non-volatile semiconductor memory area for saving user data comprising:
updating as required a temporary segment table which associates addresses of user data saved in the non-volatile semiconductor memory area with addresses in the disk memory area for the user data in a buffer memory area;
saving journals indicating update histories of the temporary segment table to a non-volatile memory area; and
reflecting contents of the temporary segment table in a saved segment table saved in a non-volatile memory area in response to a receipt of a predetermined command or one of predetermined commands from a host computer.

9. The method according to claim 8, wherein the predetermined command or commands include a command accompanied by a user data transfer between the non-volatile semiconductor memory area and the disk memory area.

10. The method according to claim 8, wherein
user data corresponding to predetermined addresses in the disk memory area are saved to the non-volatile semiconductor memory area; and
the predetermined command or commands include a command to change the predetermined addresses.

11. The method according to claim 8, wherein the predetermined command or commands include a command to transfer user data saved in the non-volatile semiconductor memory to the disk memory area.

12. The method according to claim 8, wherein the predetermined command or commands include a command to order a recovery from a mode for stopping spin of the disk and saving user data to the non-volatile semiconductor memory area.

13. The method according to claim 8, wherein the contents of the temporary segment table are reflected in the saved segment table saved in the non-volatile memory area if the size of the non-volatile memory area in which the journals are saved exceeds a reference value.
